(19) United States
(12) Patent Application Publication
(10) Pub. No.: US 2002/0195823 A1
(43) Pub. Date: Dec. 26, 2002

(54) Wave energy transducer

(76) Inventor: Abel L. Aguirre, Long Beach, CA (US)

Correspondence Address: Charles H. Thomas, CISIO & THOMAS LLP, Suite 405, 4201 Long Beach Blvd, Long Beach, CA, 90807-2022, US

(21) Appl. No.: 09/892,053

(22) Filed: Jun. 26, 2001

(51) Int. Cl. H02P 9/04; F03B 13/10; F03B 13/12

(52) U.S. Cl. 290/53

(57) ABSTRACT

A wave energy transducer is provided for converting the kinetic energy of waves moving in a body of water, such as waves in the ocean, to usable power. The wave energy transducer of the invention employs a pair of upright posts anchored to the floor of the ocean in a region subject to heavy wave activity. The posts are aligned perpendicular to the predominant direction of wave action. Mounting arms are hinged to the posts and extend in pairs toward shore and away from shore. Each of the pairs of mounting arms carries a paddlewheel, and the ends of the mounting arms are supported by floats. The floats hold the paddlewheels with their axes of rotation continually above the surface of the water and with their downwardly extending paddlewheel blades dipping into the water. Unidirectional drive mechanisms on each end of the paddlewheel axle are coupled to corresponding drive lines that in turn are connected to a power transducer, such as an electrical generator. Power is thereby extracted both from waves moving toward shore and from waves receding away from shore.

### BACKGROUND OF THE INVENTION

1. Field of the Invention

The present invention relates to a system for converting the kinetic energy of waves moving in a body of water to usable power, such as electrical current.

2. Description of the Prior Art

Various systems have been devised to attempt to extract the vast kinetic energy of water moving in a body of water and convert that energy to a usable form. While numerous systems exist for successfully converting the energy of a current of water that flows continuously in the same direction to electrical current, it has proven much more difficult to harness the vast power of the ever oscillating motion of ocean waves. Different systems have been devised that employ rotatable paddlewheels to convert the kinetic energy of ocean waves to electrical energy. However, because the waves of an ocean, sea, or lake move to and fro at different heights and surge with irregular frequency at different periods of time, a system for extracting the power of moving waves in a body of water on a commercially feasible basis has not heretofore been achieved.

### SUMMARY OF THE INVENTION

The present invention involves a system for extracting usable energy from the kinetic energy of waves of water moving in a body of water with sufficient efficiency to be commercially feasible. The wave energy transducer system of the present invention is able to compensate for the rise and fall of the water level as the waves wash in toward shore, and also as the waves retreat from shore after breaking. Also, the system of the present invention is able to extract energy from the moving waves as the waves move both toward and away from the shoreline.

The system of the invention involves the location of a power generating platform off of a seacoast in an area subject to surging waves. The system employs at least one and preferably a pair of paddlewheels secured to arms that extend generally parallel to the predominant direction of wave action. Each paddlewheel rotates about a paddlewheel axis that is oriented generally perpendicular to the predominant direction of wave surging motion. Preferably, the paddlewheels are located at intermediate locations along the lengths of the arms. The first ends of the paddlewheel mounting arms are rotatably secured to upright posts that extend upwardly from the sea floor. The second, distal free ends of the mounting arms are supported by floats that rise and fall with the surging water. The floats that are provided at the ends of the mounting arms ensure that the axes of rotation of the paddlewheels always remain well above the surface of the water at all times, with the lower ends of the downwardly extending blades of the paddles dipping into the water at all times.

As the waves surge in toward shore and then cyclically retreat, complementary unidirectional drive mechanisms are alternatively engaged by the rotating paddlewheel to transmit rotary drive shaft outputs to a power transducer, such as an electrical generator. Rotation of the paddlewheel in one direction as the waves move in toward shore engages one of the unidirectional drive mechanisms, while disengaging the other. The engaged unidirectional drive mechanism provides a driving output to its drive line, while the other unidirectional drive mechanism is disengaged. As the waves reach shore and then wash back out to sea, the direction of rotation of the paddlewheel is reversed. This reversal in direction of paddlewheel rotation disengages the first unidirectional drive mechanism while engaging the unidirectional drive mechanism that was previously disengaged. Thus, regardless of the direction of paddlewheel rotation, there is a continuous driving output provided to the power transducer as long as wave action in either direction exists.

Each unidirectional drive mechanism may be formed of a ratchet and pawl system. The teeth of each ratchet are oriented in a direction so that rotation of the paddlewheel axle in one direction urges the pawl into engagement with a proximately located ratchet tooth. The ratchet teeth of the other unidirectional drive mechanism are oriented in the opposite direction, so that rotation of the paddlewheel axis causes the ratchet teeth to idle past the pawl without imparting any driving force into the drive system. Consequently, a first of the unidirectional drive mechanisms is engaged as the waves surge in toward shore, while the other unidirectional drive mechanism is disengaged. However, once the waves break upon the shore and the wave surge reverses direction, a returning surge rotates the paddlewheel in the opposite direction of rotation. The pawl which was previously idling past the ratchet teeth in the second unidirectional drive mechanism thereupon engages a proximately located tooth, while the previously engaged pawl in the first unidirectional drive mechanism disengages and idles past the teeth of its ratchet. Although the paddlewheels rotate to and fro in opposite directions, they provide driving outputs to the power transducer as long as there is any paddlewheel rotation.

The drive shafts that are rotated by the paddlewheel or paddlewheels are coupled through gears and drive shafts to rotate a flywheel that is mounted above the surface of the water between the upright support posts. The flywheel receives driving inputs of variable speed and in alternation from the different drive lines. However, the flywheel has a sufficient mass so that it rotates at a fairly constant speed. Rotation of the flywheel drives one or more electrical power generators which have power output cables running to the shore. The overall operation of the system thereby converts the energy of the surging wave action of the sea into usable electrical power.

In one broad aspect the present invention may be considered to be an apparatus for extracting power from the wave action of a body of water. The wave energy transducer of the invention is comprised of at least one paddlewheel, a pair of support posts, at least one pair of paddlewheel mounting arms, at least one float, couplings that mount the paddlewheel for rotation between the mounting arms, a pair of unidirectional drive mechanisms, and a power transducer coupled to receive driving inputs from the unidirectional drive mechanisms. The power transducer is preferably an electrical generator.

Each paddlewheel has opposing ends and is positioned upon the surface of a body of water. Each paddlewheel is horizontally oriented and has a paddlewheel axis of rotation and blades extending radially relative to the axis of rotation. The support posts are anchored to the floor of the body of water and project upwardly to extend above the surface of the water. The support posts are aligned with each other parallel to the paddlewheel axis of rotation. Each of the mounting arms has first and second ends. The first ends of the mounting arms in each pair of mounting arms are secured to a separate one of the posts for rotation relative thereto about a common surge rotation axis. The surge rotation axis lies parallel to the paddlewheel rotation axis. The mounting arms extend laterally from the posts above the body of water.

The floats are secured to the second, free ends of the paddlewheel mounting arms remote from the first ends thereof. The floats are preferably secured to the second, free ends of the paddlewheel mounting arms. The floats hold the paddlewheel axis of rotation above the surface of the body of water with some of the blades projecting into the body of water. As a result, wave action of the body of water rotates the blades to and fro in opposite directions about the paddlewheel axis of rotation.

A pair of unidirectional drive mechanisms are provided for each paddlewheel, one at each end of the paddlewheel. The unidirectional drive mechanisms are arranged for engagement by rotation of the paddlewheel in opposite directions. Consequently, the unidirectional drive mechanisms are engaged to provide a driving output, one at a time, depending upon the direction in which the wave action of the body of water rotates the paddlewheel blades. The power transducer is coupled to receive driving inputs from the unidirectional drive mechanisms.

A flywheel is preferably interposed between the drive lines and the power transducer. The flywheel receives inputs from the unidirectional drive mechanisms and provides a power output to the power transducer. Depending upon the configuration of the drive lines, it is sometimes necessary to provide a direction reversing gear or some other direction reversing mechanism in at least one but less than all of the drive lines to ensure that all driving inputs to the flywheel rotate the flywheel in the same direction.

Because the drive shafts of the drive lines can be rather lengthy it is advisable to provide separate universal joints for each drive line. The universal joints are located between each of the unidirectional drive mechanisms and the power transducer. The provision of universal joints ensures that power is transmitted along the drive lines despite bending forces that act upon the mounting arms. Such bending forces can frequently arise due to water movement in directions transverse to the predominant direction of wave action.

While the floats may be joined to the mounting arms at varying locations along the lengths of the mounting arms, preferably the floats are joined to the second, free ends of the mounting arms. The paddlewheel may also be mounted between the mounting arms at the free end extremities, that is, at the second ends of the mounting arms. Alternatively, the paddlewheel may be located at some intermediate location between the first and second ends of the mounting arms.

The preferred embodiment of the invention employs two pairs of mounting arms extending in opposite lateral directions from the support posts. Each of the pairs of mounting arms is rotatable relative to the support posts independently of the other pair. The pairs of mounting arms are coupled to separate floats, a separate paddlewheel, and a separate pair of unidirectional drive mechanisms in the manner previously described. The use of two pairs of mounting arms, one pair extending toward shore and the other away from the shore essentially doubles the power output capacity of the transducer system over an embodiment employing a single pair of mounting arms.

In another aspect the invention may be considered to be an apparatus for converting power from wave action in a body of water to useful energy. The apparatus is comprised of a pair of upright stanchions anchored to a stationary surface beneath the body of water. The stanchions project upwardly above the surface of the body of water. The stanchions are aligned with each other transverse to a dominant direction of wave action. Preferably, the stanchions are aligned with each other perpendicular to the predominant direction of wave action.

At least one elongated mounting arm extends laterally from each of the stanchions. The mounting arms each have first and second opposing ends. Couplings secure the first ends of the mounting arms to the upright stanchions at locations above the surface of the body of water. The first ends of the mounting arms are thereby mounted for rotation about a common surge rotation axis.

At least one float is attached to the mounting arms remote from the first ends thereof. As a result the float maintains the mounting arms above the surface of the body of water despite fluctuations in water level due to wave action.

A paddlewheel having a paddlewheel axis of rotation and a plurality of blades extending radially relative thereto is mounted for rotation between the mounting arms. Consequently, the float at all times maintains the paddlewheel axis of rotation above the surface of the body of water with some of the blades projecting into the body of water. Preferably a pair of floats of the type described are provided. Also, the floats are preferably coupled to extremities of the second ends of the mounting arms. The paddlewheel is preferably mounted to the mounting arms at a position between the first and second ends of the mounting arms.

A pair of unidirectional drive mechanisms are located on the paddlewheel. These two unidirectional drive mechanisms are respectively engaged by rotation of the paddlewheel in each of two opposite directions about the paddlewheel axis of rotation. A separate drive line is coupled to each of the unidirectional drive mechanisms. An energy transducer receives driving inputs alternatively from each of the separate drive lines. The energy transducer is preferably comprised of at least one electrical generator. Also, a flywheel is preferably interposed between the drive lines and the energy transducer.

The invention may be described with greater clarity and particularity by reference to the accompanying drawings.

### DESCRIPTION OF THE DRAWINGS

FIG. 1 is a perspective view of a portion of a preferred embodiment of a wave energy transducer according to the present invention.

FIG. 2 is a side elevational view of the complete wave energy transducer shown in FIG. 1 illustrated during a surge of waves in a body of water moving toward shore.

FIG. 3 is a side elevational view of the wave energy transducer shown in FIG. 2 shown during the backwash of waves retreating from shore.

FIG. 4 is a detailed diagram of the operating portion of a single one of the unidirectional drive mechanisms employed in the invention.

### DESCRIPTION OF THE EMBODIMENT

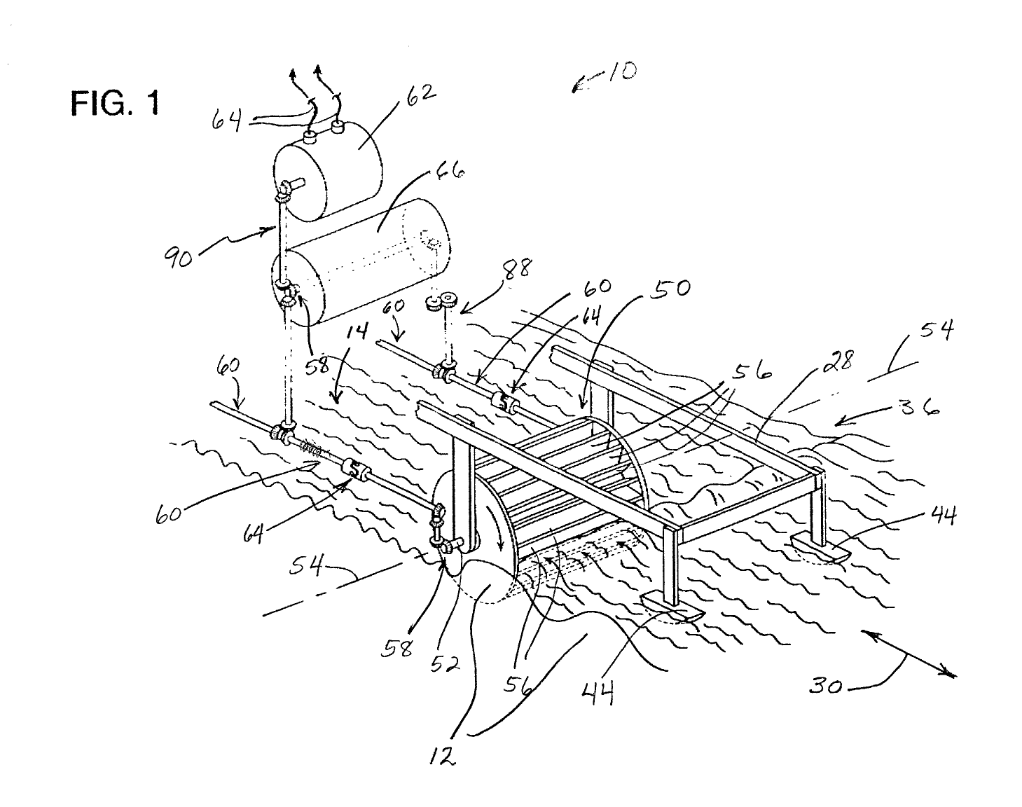

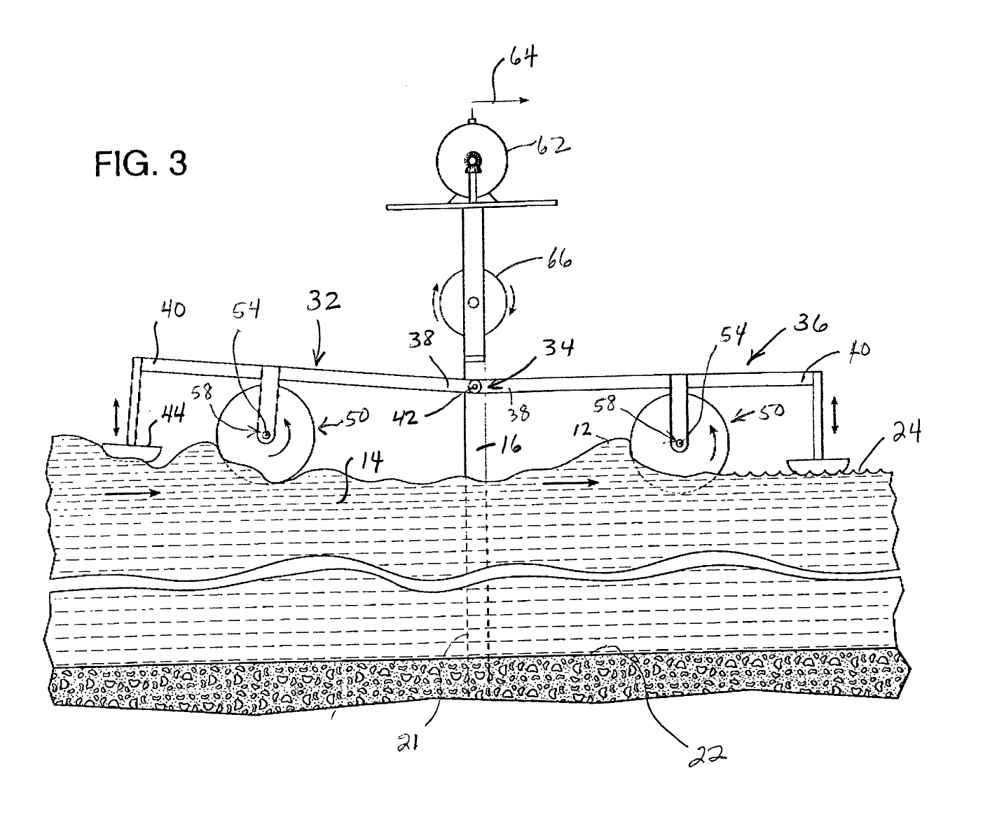

FIG. 1 illustrates a wave energy transducer indicated generally at 10 for converting the energy of waves 12 moving in a body of water 14, which may be an ocean, a sea, or a lake. The wave energy transducer 10 includes a pair of upright posts or stanchions 16 having lower extremities 21, as illustrated in FIG. 3, which are anchored relative to the floor 22 of the body of water 14. The posts 16 are aligned with each other generally parallel to the shore and in a direction perpendicular to the predominant direction of wave action, which is indicated at 30 in FIG. 1. The posts 16 extend upwardly above the surface 24 of the body of water 14.

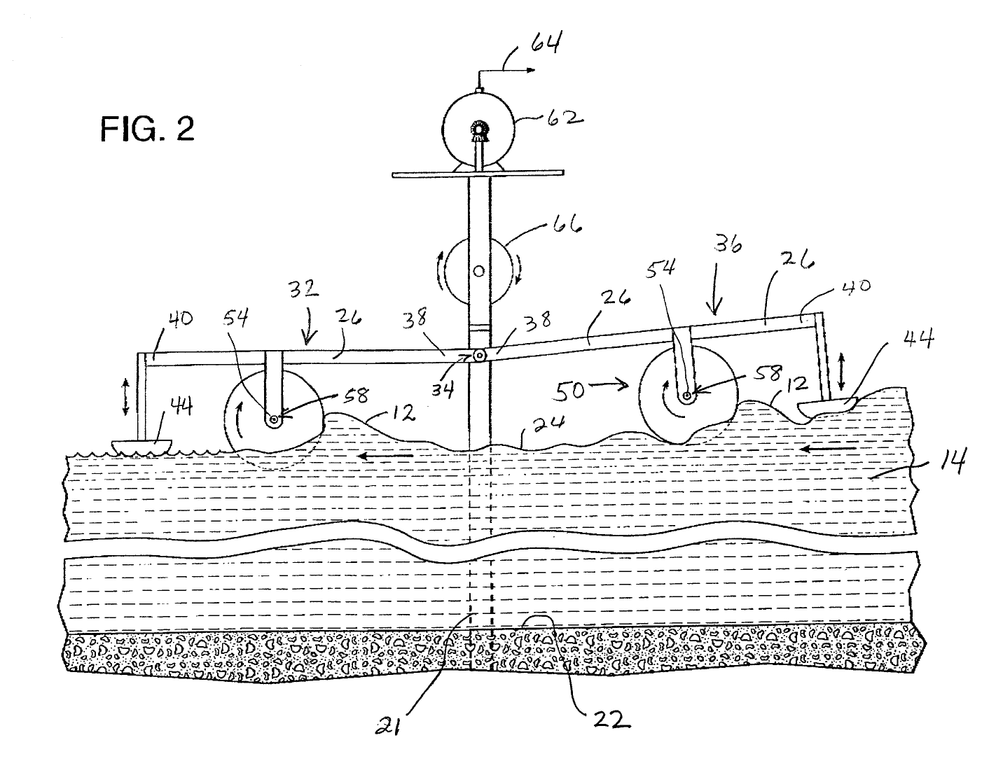

Two pairs 32 and 36 of mounting arms 26 and 28 are connected to the upright posts or stanchions 16. Both pairs of mounting arms 26 and 28 are rotatably secured by couplings 34 to the upright posts 16. The mounting arms 26 and 28 of the first mounting arm pair 32 extend in a direction toward shore and generally parallel to the predominant direction of wave action 30. The second mounting arm pair, indicated at 36, extends in an opposite direction, away from shore and also generally parallel to the predominant direction of wave action 30. As illustrated in FIGS. 2 and 3, the pairs of mounting arms 32 and 36 extend in opposite lateral directions from the upright posts 16. Each mounting arm pair 32 and 36 is coupled for rotation to the upright posts 16 by the couplings 34 independent of the other pair of mounting arms.

Each of the mounting arms 26 and 28 has a first end 38 and an opposite end 40. The mounting arm couplings 34 rotatably connect the first ends 38 of each of the mounting arms 26 and 28 to a separate one of the upright posts 16 for rotation about a common surge axis of rotation, indicated at 42 in FIGS. 2 and 3.

A float or pontoon 44 is secured to each of the mounting arms 26 and 28 remote from the first end 38 thereof, at the distal extremity of the second end 40 of each mounting arm. The floats 44 maintain the second ends 40 of the mounting arms 26 and 28 above the surface 24 of the body of water 14 despite fluctuations in the level thereof due to the action of the waves 12.

Each of the pairs of mounting arms 32 and 36 is provided with a paddlewheel 50. Each paddlewheel 50 has an axle 52 that defines a paddlewheel axis of rotation 54 that is oriented perpendicular to the predominant direction of wave action 30. Each paddlewheel 50 also has a plurality of blades 56 that are oriented radially relative to the paddlewheel axis of rotation 54.

A paddlewheel 50 is mounted between the pair of arms 26 and 28 within each pair of arms 32 and 36 at a location remote from the first ends 38 of the arms 26 and 28. While the paddlewheels 50 could be mounted at the extremities of the second, free ends 40 of the mounting arms 26 and 28, between the floats 44, they are preferably positioned at an intermediate location between the first ends 38 and the second ends 40 of the arms 26 and 28. In either case the floats 44 at all times maintain the paddlewheel axes of rotation 54 above the surface 24 of the body of water 14. At the same time the floats 44 maintain the paddlewheels 50 so that the downwardly projecting blades 56 dip into the body of water 14. As a consequence, the force of moving water produced by the waves 12 will rotate the paddlewheels 50 about the axes 54 in a direction of rotation determined by the direction of flow of the waves 12, either toward or away from shore.

Each of the paddlewheels 50 is provided with a pair of unidirectional drive mechanisms 58. The unidirectional drive mechanisms 58 for each paddlewheel 50 are coupled to the paddlewheel 50 at the opposing ends of the paddlewheel axis 54. The unidirectional drive mechanisms 58 for each paddlewheel 50 are arranged in opposition for mutually exclusive engagement with their associated paddlewheel 50 and mutually exclusive disengagement from their associated paddlewheel 50, depending upon the direction of rotation of the paddlewheel blades 56 about the paddlewheel axis 54.

Separate drive lines 60 are coupled to each of the unidirectional drive mechanisms 58 to transmit driving outputs therefrom. The drive lines 60 are all ultimately coupled to a rotary driven power converter, which may be an electrical generator 62. The electrical generator 62 receives separate driving inputs from the drive lines 60 and provides a power output responsive thereto in the form of current on electrical power lines 64.

Preferably, the wave energy transducer 10 also includes a separate universal joint 64 in each of the drive lines 60. The universal joint 64 allows smooth power transmission between the drive shaft segments in the drive lines 60 so as to accommodate bending moments that are exerted upon the mounting arms 26 and 28 due to water movement in a direction other than along the predominant direction of wave action 30. Also, a torsion spring 65 is coupled in line in each of the drive lines 60. The torsion springs 65 serve to absorb sudden torsional violent wave movement. The torsion springs dampen those impacts to produce a smoother rotational speed at the output ends of the drive lines 60.

The wave energy transducer 10 is also preferably provided with a single flywheel 66 that is mounted between the upright posts 16. All of the drive lines 60 are connected to provide driving inputs to the flywheel 66. The flywheel 66 is massive enough so that despite the irregular and discontinuous driving inputs that are provided from each of the drive lines 60, the flywheel 66 will rotate at a more or less constant speed. The steady speed of the flywheel 66 allows the electrical generator 62 to produce a fairly constant electrical power output on power transmission lines 64.

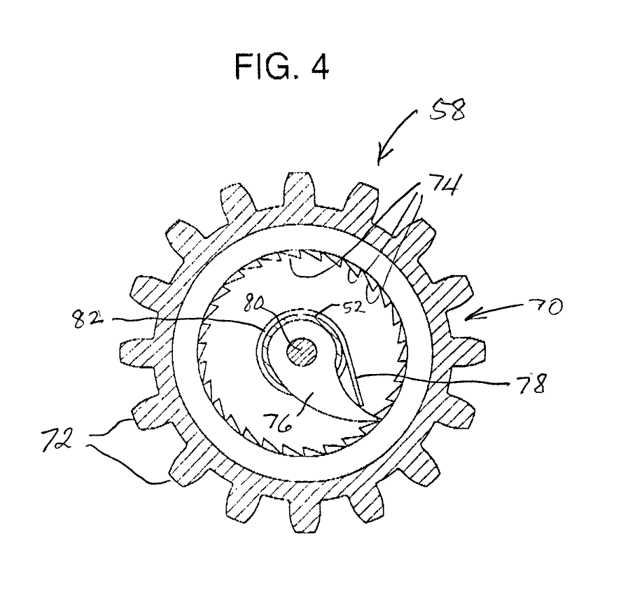

While a number of different types of unidirectional power drive mechanisms may be employed in the wave energy transducer of the invention, one suitable unidirectional drive mechanism 58 is illustrated in the detail view of FIG. 4. FIG. 4 illustrates the interior of one of the unidirectional drive mechanisms 58. Each of the unidirectional drive mechanisms 58 is formed with a gear ring 70 having outwardly projecting bevel teeth 72 for engagement with meshed teeth in a drive line 60, and radially inwardly directed ratchet gear teeth 74. The ratchet gear teeth 74 are oriented for engagement by a spring-loaded pawl 76 from a single direction. The gear ring 70 is coaxially mounted relative to the paddlewheel 50 near an end extremity on the paddlewheel axle 52. The gear ring 70 is not directly engaged with the paddlewheel axle 52, but instead is supported for rotation relative thereto by conventional bearings. The pawl 76 is rotatably mounted upon a pin 80 that extends into the end of the paddlewheel axle 52. The pawl 76 is thereby secured to the paddlewheel axle 52, but is also rotatable about the paddlewheel axis 54. A coiled wire spring 82 has one end secured relative to the paddlewheel axle 52. The other end 78 of the wire spring 82 biases the pawl 76 radially outwardly in a clockwise direction, as viewed in FIG. 4.

It can be seen that the unidirectional drive mechanism 58 engages its associated drive line 60 when the paddlewheel 50 rotates in the counterclockwise direction, as viewed in FIGS. 1 and 4. When the paddlewheel 50 rotates in the counterclockwise direction as viewed in these drawing figures the paddlewheel axle 52 rotates in a counterclockwise direction. The bias of the wire spring 82 urges the pawl 76 radially outwardly so that it engages the closest ratchet tooth 74, as illustrated in FIG. 4. Continued counterclockwise rotation of the paddlewheel axle 52 thereby carries the ring gear 70 with it, since the pawl 76 is engaged with one of the ratchet teeth 74. The bevel gear teeth 72 are thereby turned in a counterclockwise direction to impart a driving force to the drive line 60. The drive lines 60 include conventional shafts and gears that transmit rotary motion from the paddlewheel axle 52 to the axle of the flywheel 66.

On the other hand, when the paddlewheel 50 rotates in the opposite, clockwise direction as viewed in FIG. 1 and 4, the orientation of the pawl 76 is such that clockwise rotation of the paddlewheel axle 52 disengages the pawl 76 from the ratchet teeth 74. Rather, the pawl 76 merely cams over the inclined backsides of the ratchet gear teeth 74, overcoming the bias of the wire spring 82. Thus, when the paddlewheel 50 rotates in a clockwise direction as viewed in FIGS. 1 and 4, the unidirectional drive mechanism 58 located on the nearest end of the paddlewheel 50 as viewed in FIG. 1 is disengaged from the drive line 60 to which it is coupled. However, there is an identical unidirectional drive mechanism 58 located on the far end of the paddlewheel axle 52, not visible in FIG. 1. As the clockwise rotation of the paddlewheel 50 disengages the unidirectional drive mechanism 58 located on the near end of the paddlewheel axle 52, it engages the unidirectional drive mechanism 58 located on the far end of the paddlewheel axle 52 in exactly the same manner previously described.

Thus, regardless of the direction of rotation of the paddlewheel 50 a driving output is provided to either the near drive line 60 or the far drive line 60, as viewed in FIG. 1. These drive lines 60 are parallel to and respectively associated with the mounting arms 26 and 28 in the mounting arm pair 36. At the same time a driving input is received from one or the other of the drive lines 60 that are parallel to and associated with the mounting arm pair 32, but not from both at the same time.

Depending upon the type of unidirectional drive mechanisms selected, the driving outputs from the several drive lines 60 could be such that the rotational force transmitted would tend to rotate the flywheel 66 first one way, and then the other, depending upon which drive line input is engaged. It is absolutely essential for all driving inputs to turn the flywheel 66 in the same direction. Therefore, it may be necessary for a direction reversing mechanism, such as that illustrated at 88 in FIG. 1, to be inserted in the drive lines 60 on one side of the wave energy transducer 10. This direction reversing mechanism is conventional and need not be described in great detail. Similarly, all of the shafts and gear rings employed in the drive lines 60 are conventional and likewise need not be described in great detail.

In addition to the unidirectional drive mechanisms 58 employed at the ends of the paddlewheel shaft 52, there are also identical unidirectional mechanisms which serve as power transfer mechanisms located at the ends of the axle of the flywheel 66. These unidirectional power transfer mechanisms are also indicated at 58 in FIG. 1.

It can be seen that with the to and fro movement of the waves 12 in the body of water 14 driving inputs from the different drive lines 60 provide forces that rotate the flywheel 66. The flywheel 66 is massive enough so that it rotates at a fairly constant speed, despite the rather irregular driving inputs received from the different drive lines 60. The kinetic energy from the rotating flywheel 66 is provided as a power output through power transfer line 90 to the armature shaft of the electrical generator 62. As the armature of the generator 62 is rotated, usable electrical power is provided on the electrical transmission lines 64.

Undoubtedly, numerous variations and modifications of the invention will become readily apparent to those familiar with mechanical energy transducers. Accordingly, the scope of the invention should not be construed as limited to the specific embodiment depicted and described, but rather is defined in the claims appended hereto.

I claim:

1. An apparatus for extracting power from the wave action of a body of water comprising:
at least one paddlewheel having opposing ends and positioned upon the surface of a body of water and having a horizontally oriented paddlewheel axis of rotation and blades extending radially relative to said axis of rotation,
a pair of support posts anchored to the floor of said body of water and projecting upwardly to extend above the surface of said body of water and aligned with each other parallel to said paddlewheel axis of rotation,
at least a pair of paddlewheel mounting arms each having first and second ends, and said first ends of said arms in each pair are secured to a separate one of said posts for rotation relative thereto about a common surge rotation axis parallel to said paddlewheel rotation axis, and said arms extend laterally from said posts above said body of water,
floats secured to said paddlewheel mounting arms remote from said first ends thereof,
couplings that mount said paddlewheel for rotation between said mounting arms and said floats to hold said paddlewheel axis of rotation above said surface of said body of water with some of said blades projecting into said body of water, and whereby wave action of said body of water rotates said blades to and fro in opposite directions about said paddlewheel axis of rotation,
a pair of unidirectional drive mechanisms, coupled to said paddlewheel and arranged for engagement by rotation of said paddlewheel in opposite direction, whereby said unidirectional drive mechanisms are engaged to provide a driving output, one at a time, depending upon the direction in which said wave action of said body of water rotates said paddlewheel blades, and
a power transducer coupled to receive driving inputs from said unidirectional drive mechanisms.

2. An apparatus according to claim 1 further comprising direction reversing gearing coupled to one of said unidirectional drive mechanisms and said power transducer is coupled to said other unidirectional drive mechanism through said direction reversing gearing.

3. Apparatus according to claim 1 further comprising a flywheel coupled to receive inputs from said unidirectional drive mechanisms and to provide a power output to said power transducer.

4. Apparatus according to claim 1 further comprising separate universal joints located between each of said unidirectional drive mechanisms and said power transducer.

5. Apparatus according to claim 1 wherein said floats are joined to said mounting arms at said second ends thereof and said paddlewheel is mounted to said mounting arms at locations between said first and second ends thereof.

6. Apparatus according to claim 1 wherein said power transducer is an electrical generator.

7. Apparatus according to claim 1 further comprising two pairs of mounting arms extending in opposite lateral directions from said support posts, and each of said pairs of mounting arms is rotatable relative to said support posts independently of the other pair and said pairs of mounting arms are coupled to separate floats, separate paddlewheels, and a separate pair of unidirectional drive mechanisms as aforesaid.

8. An apparatus for converting power from wave action in a body of water to useful energy comprising:
a pair of upright stanchions anchored to a stationary surface beneath said body of water and projecting upwardly above the surface of said body of water and said stanchions are aligned with each other transverse to a dominant direction of said wave action,
an elongated mounting arm extending laterally from each of said stanchions, and said mounting arms each have first and second opposing ends,
couplings that secure said first ends of said mounting arms to said upright stanchions at locations above said surface of said body of water for rotation about a common surge rotation axis,
at least one float attached to said mounting arms remote from said first ends thereof whereby said float maintains said mounting arms above said surface of said body of water despite fluctuations in water level due to said wave action,
a paddlewheel having a paddlewheel axis of rotation and a plurality of blades extending radially relative thereto, mounted for rotation between said mounting arms whereby said float at all times maintains said paddlewheel axis of rotation above said surface of said body of water with some of said blades projecting into said body of water,
a pair of unidirectional drive mechanisms located on said paddlewheel and respectively engaged by rotation of said paddlewheel in each of two opposite directions about said paddlewheel axis of rotation,
a separate drive line coupled to each of said unidirectional drive mechanisms, and
an energy transducer that receives driving inputs alternatively from each of said separate drive lines.

9. An apparatus according to claim 8 further comprising a pair of floats as aforesaid, and said floats are coupled to said second ends of said mounting arms.

10. An apparatus according to claim 9 wherein said paddlewheel is mounted to said mounting arms at a position between said first and second ends thereof.

11. An apparatus according to claim 10 further comprising a flywheel interposed between said drive lines and said energy transducer, and wherein said energy transducer is comprised of at least one electrical generator.

12. An apparatus according to claim 8 further comprising separate universal joints in each of said drive lines.

13. A wave energy transducer for converting energy of waves moving in a body of water to usable power comprising:
a pair of upright posts anchored relative to the floor of said body of water and extending upwardly above the surface of said body of water,
at least a pair of mounting arms having first and second ends,
mounting arm couplings rotatably connecting said first ends of each of said mounting arms in each pair to a separate one of said upright posts for rotation about a common surge axis of rotation,
at least one float secured to each pair of mounting arms remote from said first ends thereof to maintain said second ends thereof above said surface of said body of water despite fluctuations in the level thereof due to wave action,
a paddlewheel for each pair of mounting arms having a paddlewheel axis of rotation and a plurality of blades oriented radially thereto, and said paddlewheel is mounted between said mounting arms in each pair remote from said first ends thereof for rotation relative thereto, whereby said float at all times maintains said paddlewheel axis of rotation above said surface of said body of water with some of said blades dipping into said body of water,
a pair of unidirectional drive mechanisms coupled to said paddlewheel at said paddlewheel axis, and said unidirectional drive mechanisms are arranged in opposition for mutually exclusive engagement with said paddlewheel and mutually exclusive disengagement from said paddlewheel depending upon the direction of rotation of said paddlewheel blades about said paddlewheel axis,
separate drive lines coupled to each of said unidirectional drive mechanisms to transmit driving outputs therefrom,
a rotary driven converter that receives separate driving inputs from said drive lines and provides a power output responsive thereto.

14. A wave energy transducer according to claim 13 further including two pairs of mounting arms as aforesaid, each of said pairs of mounting arms having separate floats, a separate paddlewheel, separate pairs of unidirectional drive mechanisms, and separate drive lines as aforesaid.

15. A wave energy transducer according to claim 14 further comprising at least one direction reversing mechanism located in at least one and fewer than all of said drive lines.

16. A wave energy transducer according to claim 14 wherein said pairs of mounting arms extend in opposite lateral directions from said upright posts, and each pair of mounting arms is coupled for rotation to said upright posts independent of the other pair of mounting arms.

17. A wave energy transducer according to claim 16 wherein there is a separate universal joint in each of said drive lines.

18. A wave energy transducer according to claim 16 further comprising a single flywheel, and all of said drive lines are connected to provide driving inputs to said flywheel.

19. A wave energy transducer according to claim 17 further comprising separate unidirectional power transfer mechanisms interposed between each of said drive lines and said flywheel.

20. A wave energy transducer according to claim 18 wherein said rotary driven converter is an electrical generator.
